(19) United States
(12) Patent Application Publication
(10) Pub. No.: US 2009/0116003 A1
(43) Pub. Date: May 7, 2009

(54) APPARATUS FOR DETECTING JOINTS IN RUBBER SHEETS

(75) Inventor: Silvio Crotti, Ranica Bergamo (IT)

Correspondence Address: EPSTEIN DRANGEL BAZERMAN & JAMES, LLP, 60 EAST 42ND STREET, SUITE 820, NEW YORK, NY, 10165, US

(73) Assignee: FIRMA TEXMAG GMBH VERTRIEBSGESELLSCHAFT, Thalwil (CH)

(21) Appl. No.: 10/594,653

(22) PCT Filed: Mar. 24, 2005
(86) PCT No.: PCT/EP2005/003189

§ 371 Date: Dec. 8, 2008

(30) Foreign Application Priority Data
Mar. 27, 2004 (DE) 102004015110.5
Jun. 3, 2004 (IT) MI2004A001122

(51) Int. Cl. G01N 21/88

(52) U.S. Cl. 356/237.1

(57) ABSTRACT

A method for detecting defects in, and/or geometrical characteristics of, at least one joint or splice of sheet pieces, in a unloaded state, characterised by the following steps: a. subjecting said joint or splice to a non-unidirectional electromagnetic radiation; b. performing a two-dimensional detection of the radiation reflected or refracted by said joint or splice; c. generating output signals corresponding to said two-dimensional detection; d. determining possible defects or the geometrical characteristics of at least part of said joint or splice, by analysing, said output signals.

### FIELD OF THE INVENTION

The present invention relates to a method and to an apparatus for detecting defects in and/or detecting geometrical characteristics of a joint or splice of two rubber or other flexible material sheets which is particularly suitable for making dimensional checks and detecting defects in joints present in a rubber belt for preparing the carcass and/or waist of a pneumatic tyre for vehicles. With the term “carcass” is generally meant, both herein and below, the resistant structure, for example consisting of rubber sheets which are either provided or not with metal or synthetic material cords, which is placed below the tread of the pneumatic tyre, whereas with the term “waist” is meant that reinforcement ring also being made of rubber sheets with metal cords, which is interposed between the carcass and tread and destined, in a radial pneumatic tyre, to force the carcass to take a flattened shape.

### PRIOR ART

In the manufacture of pneumatic tyres for vehicles, it is known to make the pneumatic tyre carcass (and/or waist) from at least one layer of rubber bands or sheets being optionally provided with metal or synthetic material cords, which are joined or spliced to each other two by two to form a continuous belt. The subsequent operations of cutting, modelling and optional vulcanization of said belt lead to the definite provision of said carcass and/or waist of the pneumatic tyre.

The bands or sheets making up the belt, which are either made of rubber or other flexible synthetic material, generally consist of sheet pieces, i.e. with two dimensions prevailing over a third dimension, which are spliced or joined according to various procedures, usually by means of automatic machines.

Joints or welds of sheets of a usually synthetic flexible material, however, are also used in the manufacture of tubes made of thermoplastic material; preparation of paper reels, or manufacture of polymer films.

The various procedures of splicing and/or joining said rubber or other flexible material sheets differ from each other not only based on the different techniques according to which the margins are fixed to each other, such as welding or bonding, but also based on the different alternative procedures of juxtaposing said margins to form the desired product.

In the pneumatic tyre manufacture field, the most widespread procedures for juxtaposing rubber sheets are: simple front-approaching of consecutive margins (i.e. matching the sheet surfaces having a smaller size), optionally along a line that, in plan view, extends obliquely relative to the longitudinal direction of the belt; continuous overlapping, with deformation in the joining area, of these sheets along the greater surfaces of the sheets; or alternate overlapping, i.e. one on top of the other and so on, of said end margins.

In the manufacture of pneumatic tyres, regardless of the procedure of juxtaposing the rubber sheets, however the quality of the joints or splices of the margins substantially determines the quality of the carcass and/or waist of the pneumatic tyre, and hence determines the end quality of a pneumatic tyre. Accordingly, checking the quality of the joint or splicing between said rubber sheets is a critical aspect in the manufacturing process of the pneumatic tyres of the type having a carcass and/or waist obtained from a belt with joined or spliced rubber sheets.

In greater detail, the joining or splicing of sheets may suffer from several defects, such as the absence of co-axiality of two consecutive sheets, which determines a non-rectilinear development of the belt edges, the irregular arrangement in the transversal direction of the overlapped margins of two consecutive rubber sheets, when using this juxtaposition procedure, the partial or total releasing of the juxtaposed margins of two joined or spliced sheets; the imperfect alignment of these juxtaposed margins.

In the manufacture of pneumatic tyres, the above defects and other defects, such as those due to possible dimensional irregularities, either of joints or splices between subsequent rubber sheets, should be detected and corrected before carrying out the subsequent operations of modelling, and optionally, vulcanization on the carcass and/or waist in order to avoid that the pneumatic tyre may deform.

In the case of processes other than that of manufacturing waists and/or carcasses of pneumatic tyres, identifying the above defects in the joints of margins of flexible materials, which are juxtaposed according to similar procedures as those mentioned above, is often required in order to achieve an acceptable quality for the finished product.

Detecting defects, including those due to dimensional irregularities, that may be present in the joints or splices of flexible material margins, particularly when manufacturing waists and/or carcasses of pneumatic tyres, is usually carried out in a manual manner with a considerable waste of resources. A skilled operator inspects the joint or splice and determines whether this joint or splice requires to be subjected to further correcting processing.

Alternatively, it is known to detect defects that may be present in the joint or splice of rubber or other flexible material sheets using an apparatus that, being provided with suitable mechanical tracers consisting of a plurality of rods having the same length and being free to shift in a direction orthogonal to the belt, is capable of checking the arrangement and the connection taken by the juxtaposed, and either joined or spliced margins of for example two rubber sheets. The rod-shaped tracers, at an end thereof, are contacted with the joint or splice between the two juxtaposed margins and are then left free to follow the edge being defined by this joint or splice. Defects in the joint or splice are then determined by detecting, for example by means of optical sensors, the edge being defined by the free ends of the tracers.

This defect-detecting apparatus, though allowing automatic inspection of the joints or splices between flexible material sheets, either joined or spliced, provides indications relating only to macroscopic defects in the joints or splices, due to the poor sampling resolution of the tracers, due to the non-infinitesimal dimensions of the same and their mutual distance. Furthermore, the apparatus described above is particularly complicated, and hence poorly reliable from a mechanical point of view.

The patent application EP-A-0289101, in the name of VMI EPE HOLLAND BV, relates to an apparatus suitable to detect defects that may be present in the joints between juxtaposed margins of rubber sheets of a belt for manufacturing waists and/or carcasses of pneumatic tyres, comprising a plurality of optical sensors detecting a laser beam directed onto the joint and reflected therefrom.

Particularly, the VMI apparatus provides that the belt consisting of mutually welded rubber sheets, is wound on a rotating drum and at least one laser beam, i.e. a coherent and unidirectional beam of electromagnetic radiations, is directed to the belt, at the weld, according to an oblique direction relative to the normal to the belt. A linear CCD video camera, suitably arranged relative to the belt, detects the linear image of the laser beam being partially reflected from the weld.

Using directional electromagnetic radiation sources, and particularly of sources capable of emitting a coherent light beam, implies that the area reached by the unidirectional beam is a point or at most linear one, and hence the detected area is necessarily restricted. On the one hand, this ensures high precision in detecting the beam being reflected and a certain simplification in the processing of the acquired signal, but on the other hand, due to said restriction of the detected area, this also implies that there may occur possible positioning errors of the beam on the joint, omission of the detection of defects that may be present in areas of the joint, which are sometimes critical for the structure of the carcass and/or waist of the pneumatic tyre (or the product provided with the joint), and the poor capacity of detecting the type of defect that may be present in the joint.

The teachings of German patent application DE-A-10036010 in the name of THYSSENKRUPP are substantially similar to the application EP-A-0289101 in the name of VPI.

EP-A-0536705, in the name of BRIDGESTON/FIRESTONE, teaches to detect edges of a lateral splice in a web of a tire body ply material by using output signals coming from laser sensors placed above and below the web, and from an encoder tracking the movement of said web. Laser sensors monitor the surface contour of the web along respective lines defined by the travel of the web. Peak signals coming from at least two consecutive laser sensors are compared with signals coming from the encoder in order to determine the spacing between said peak signals and, accordingly, to determine the splice width at the points sensed by the laser sensors.

Another time, zones detected by the device disclosed in EP-A-0536704 are linear zones of the splice and, moreover, encoder signals are needed in order to determine just one geometrical characteristic of the splice.

It is an object of the present invention to provide a method and an apparatus for detecting geometrical characteristics of and/or detecting defects in joints or splices of rubber or other flexible material sheets which is free from the drawbacks of prior art, as mentioned above.

Accordingly, it is an object of the present invention to provide an apparatus for making dimensional checks and/or detecting defects in joints or splices of rubber or other flexible material sheets that ensures accurate detection of the defects that may be present in the joints or splices between said margins that possibly extends either over a great part or all the juxtaposition area between two consecutive margins.

Another object of the present invention is to provide an apparatus for detecting geometrical characteristics of and/or detecting defects in joints or splices of rubber or other flexible material sheets which is structurally non-complicated and particularly quick in detecting these defects.

A further object of the present invention is to provide a method for detecting defects in, and/or geometrical characteristics of, the joints or splices of rubber or other flexible material sheets, which is effective and easy to carry out, and which does not require the sheets involved in said splice or joint to be subjected to a certain load, e.g. stretched.

### SUMMARY OF THE INVENTION

These and other objects are achieved by means of the method according to the first independent claim and the subsequent dependent claims thereof and the apparatus according to the twelfth independent claim and the subsequent dependent claims thereof.

According to the present invention, the apparatus for detecting defects and/or geometrical characteristics in joints or splices of rubber or other flexible material sheets comprises at least one source of electromagnetic radiations which are suited to be directed towards at least one joint or at least one splice, and one or more sensors which can detect the radiation reflected or refracted by the joint or splice. Advantageously, according to the present invention, the radiation source employed in this apparatus is a source of electromagnetic radiations which are not unidirectional and said one or more sensors carry out a two-dimensional detection of said reflected or refracted radiation.

In this way, the electromagnetic radiation reaching the joint or splice is a radiation that is substantially diffused all over the joint or splice, and the subsequent detection of the radiation being either reflected or refracted by the latter is carried out by means of one or more sensors having, either individually or combined to each other, a two-dimensional detecting window that may virtually encompass the whole joint or splice, or at least an extended area of interest of said joint or splice. This implies that, unlike in prior art, the detection of the defects is not limited to joint or splice linear portions and this detection is accordingly more accurate and reliable.

In the event that, according to a preferred embodiment of the present invention, the source/s of electromagnetic radiations which are not unidirectional is/are either luminous, infrared or ultraviolet sources, the sensors detecting the reflected/refracted radiation may suitably consist of matrix CCD or C/MOS video cameras, which are provided with a detection plane preferably allowing to acquire the image of the whole joint or splice.

Alternatively, the detection sensors may be linear CCD or C/MOS video cameras operatively linked to each other to provide, either directly or indirectly, a two-dimensional detection of the image of the whole joint or splice, or of a great area thereof.

This specific structure of the apparatus according to the present invention is easy to implement, also due to the fact that the components thereof are widely available on the market.

According to another particular aspect of the present invention, furthermore, the non-unidirectional radiation sources may be at least two, one of which being suitable to be placed above and the other below the joint or splice, and consequently the two-dimensional detection sensors are at least two, one of which being suitable to be placed above and the other below said joint or splice, such that the defects that may be present on either face of the product being obtained from joining or splicing the rubber or other flexible material sheets can be detected.

The apparatus according to the invention may further comprise means for conveying said sheets in correspondence to said at least one source and to said one ore more sensors, or vice-versa for conveying said at least one source and said one ore more sensors in correspondence to said sheets, and processing means for analyzing the output signal from said one or more sensors.

According to a further aspect of the present invention, there is provided a method for detecting defects and/or geometrical characteristics in at least one joint or splice of sheet pieces, said sheet pieces being in a unloaded state, comprising the following steps:

a. subjecting said joint or splice to a non-unidirectional electromagnetic radiation;

b. performing a two-dimensional detection of the radiation reflected or refracted by the joint or splice;

c. generating output signals corresponding to the two-dimensional detection;

d. determining possible defects or the geometrical characteristics of at least part of said joint or splice, by analysing said output signals.

The two-dimensional detection of the non-unidirectional radiation, either reflected or refracted from the joint or splice of two consecutive margins (or end edges) of the belt allows, as stated above, to achieve high accuracy and effectiveness in the detection of geometrical characteristics (e.g. width, length . . . ) of joints or splices and in the detection of defects, including the dimensional ones, which may be present in these joints or splices.

According to a preferred aspect of the method of the present invention, said steps of subjecting the joint or splice to a non-unidirectional electromagnetic radiation and of performing a two-dimensional detection of the radiation reflected or refracted by said joint or splice are accomplished only after the step of detecting the transit of at least one splice or joint in correspondence to said at least one source of non-unidirectional electromagnetic radiation and to one or more sensors for performing the afore-said two-dimensional detection.

According to another preferred aspect of the method of the present invention, said output signals of the two-dimensional detection correspond to an image of at least part of said joint or splice (i.e. they are video signals) and these output signals are digital or digitalized signals. In this case, the analysis of the output signals may comprise a step of treating said image output signals by means of a convolution mask, or a Sobel filter, or a profile detector, or a blob analysis or a Fast Fourier Transformation (FFT), or a derivative analysis. Moreover, a step of detecting the edges of the objects in said image, and a subsequent step of measuring and/or analysing at least one of said edges may be provided.

According to another aspect of the claimed method, it is envisaged a calibrating phase including the following steps:

a. placing a straightedge in correspondence to at least one source of non-unidirectional electromagnetic radiation and to one or more sensors for performing said two-dimensional detection;

b. subjecting said joint or splice to a non-unidirectional electromagnetic radiation;

c. performing a two-dimensional detection of the radiation reflected or refracted by said joint or splice;

d. generating calibration output signals corresponding to said two-dimensional detection;

e. storing said calibration signals as a comparison value for subsequent output signals.

In this case, possible misalignments of said one or more two-dimensional sensors could be verified and a correction term could be inserted in the output signals thereof, in order to take into account said possible misalignments.

### BRIEF DESCRIPTION OF THE DRAWINGS

Several embodiments of the present invention will be explained below by way of non-limiting example, with reference to the detection of defects in joints of rubber sheets for the manufacture of waists and/or carcasses of pneumatic tyres, with the aid of the following figures in which:

FIG. 1 is a general layout of an apparatus according to a particular aspect of the present invention;

FIG. 2 is a schematic side view of the assembly consisting of a source of non-unidirectional radiations and a two-directional sensor detecting the radiation belonging to the apparatus from FIG. 1, illustrated while carrying out a defect-detecting activity in a joint;

FIG. 3 is a top view of the joint of two rubber sheets as represented in FIG. 2;

FIG. 4 is a schematic perspective view of another embodiment of the apparatus according to the present invention;

FIG. 5 is a schematic perspective view of a further embodiment of the apparatus according to the present invention;

FIG. 6 is a schematic perspective view of a further embodiment of the apparatus according to the present invention; and

FIG. 7 is a block diagram illustrating a possible implementation of the method for detecting defects according to the present invention.

### DETAILED DESCRIPTION OF SOME PREFERRED EMBODIMENTS OF THE INVENTION

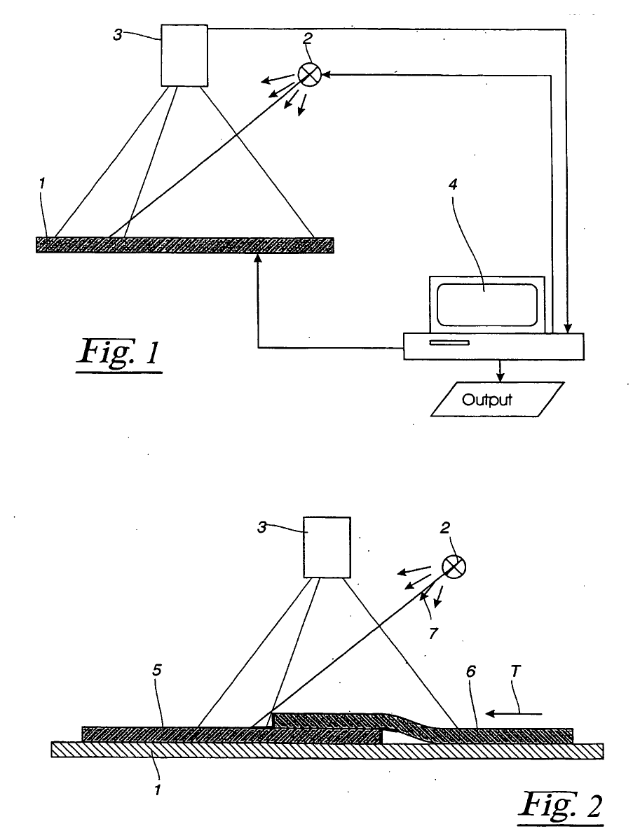

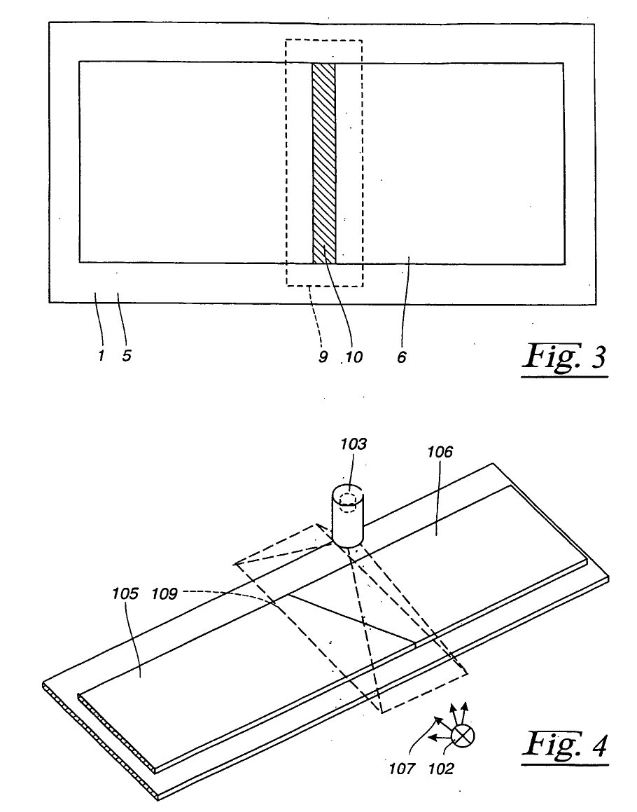

Referring first to FIG. 1 to 3, the apparatus for detecting geometrical characteristics (e.g. making dimensional checks) and/or detecting defects in joints or splices of rubber or other flexible material sheets 5, 6 forming a belt or other belt-like product, according to the present invention, comprises means 1 for placing a joint or splice (for example obtained by means of welding) in correspondence to at least one source 2 of electromagnetic radiations directed to said joint or splice, and in correspondence to at least one sensor 3 detecting the radiation, either reflected or refracted from the joint or splice.

It should be observed that, despite in the apparatus described herein there are provided and described the means 1 for placing a joint or splice in correspondence to at least one source 2 of electromagnetic radiations and at least one detection sensor 3, these means 1 may as well not be integrated in the detection apparatus according to the present invention, and may be then provided on another auxiliary apparatus, which is separated from the apparatus claimed herein. Moreover, other suitable means for conveying said at least one source 2 of electromagnetic radiations and said at least one detection sensor 3 in correspondence to the joint or splice to be detected could be alternatively used.

It should be further observed that with “flexible material sheet” above, here and below is meant an end portion of a flexible material product having two dimensions which are much greater than a third one. The joint, or splice, of two of these consecutive sheets is normally carried out so that, when they are mutually juxtaposed, both joined or spliced margins are substantially arranged parallel or co-planar to each other, according to the procedures detailed above.

Advantageously, as described above, the source 2 emits non-unidirectional radiation 7, i.e. it emits radiations 7 generally diffused within a substantially conical irradiation volume, and sensor 3 is capable of carrying out detections of the radiation 8 reflected from the sheets 5, 6 (such as illustrated in the figures), or refracted therefrom (this case has not been illustrated), according to two directions, being preferably orthogonal to each other, i.e. according to a plane crossed by said reflected 8 or refracted radiation.

The output signals from sensor 3 may be then sent to a control and processing system 4 that can provide its analysis of the signal acquired to an operator, signal the presence of supposed defects in the joints or splices, and be possibly provided with a logic capable of automatically controlling the operation of the whole apparatus. Alternatively, the signals from the sensor 3 may be simply displayed on a screen available for the operator to visually identify the defects that may be present in the joints or splices.

The processing and control system 4 can be a common processor available on the market, a PLC, or any other micro-processor system that may also be integrated in sensor 3.

According to a preferred aspect of the present invention,. the sensor 3 is a detection sensor of the matrix type which, in case the source 2 or electromagnetic radiations is a luminous or infrared source, may comprise a matrix CCD or C/MOS video camera, preferably capable of acquiring images with at least 64 levels of grey and preferably 256 grey levels, or color images.

Alternatively, in an embodiment of the present invention that is not illustrated, sensor 3 may consist of two or more linear CCD or C/MOS video cameras which are operatively linked to output, either directly or indirectly, a two-dimensional detection of said radiation either reflected or refracted from the joint.

When using a video camera 3, also of the traditional type with electron gun, a lens (not shown) focuses on the image plan of the video camera 3 an acquisition area 9 that is illuminated by the source 2 of diffused light, or non-unidirectional infrared radiation, where a joint or splice between the sheets 5, 6 of two consecutive sheets in the belt (or web) is placed by said means 1. The video camera 3 sends, in turn, a signal that is univocally related with the acquired image, preferably in a digital form, to the processing and control system 4.

The acquisition area 9 of the radiation reflected from the sheets 5, 6, as may be seen in FIG. 4, is substantially rectangular and may encompasses the whole extension of the joint or splice to be inspected, or a great portion thereof.

Alternatively, two or more acquisition (two-dimensional) areas could be provided in correspondence to the lateral sides of the belt formed by sheets 5, 6, thus simply allowing for the detection of possible misalignments in the end edges of the sheets involved in the joint or splice, without inspecting the whole joint or splice.

In the particular embodiment of the apparatus according to the present invention as illustrated in FIG. 1-3, in which the sensor 3 is preferably a CCD (or C/MOS) video camera and the source 2 is a luminous source, both this CCD (or C/MOS) video camera 3, and the luminous source 2 are placed above the acquisition area 9, the belt (or web) formed by sheet pieces being caused to pass therethrough, such that the CCD (or C/MOS) video camera 3 is capable of acquiring the luminosity (radiation intensity) of the belt, in correspondence to this region 9, following the reflection 8 of light 7 on the same belt.

The optical axis of the video camera 3, in the embodiment described herein, is further substantially orthogonal to the laying plane of the belt, whereas the optical axis of the luminous source 2 is substantially oblique relative to the normal to said laying plane, such that the luminous rays 7 emitted can hit the joint or splice area of both sheets 5, 6 in a biased (inclined) manner.

As will be seen, this allows to use the shadow 10, which in the case of joint with overlapped margins is projected from the upper margin onto the lower margin, for measuring the joint or splice.

The means 1, preferably of the type capable of driving the rubber or other flexible material belt, or other belt-like product, relative to the source 2 and sensor 3, may consist for example, according to known technique, of a linear conveyor or rotatable drum on which there is arranged this belt or belt-like product.

Alternatively, without departing from the scope of the present invention, these means 1 may be configured such as to move the unit made up of the sensor 3 and source 2 until a joint or splice of the belt, or belt-like product, without requiring to move the belt.

These means 1 may be capable of feeding the belt in an intermittent manner, such that when a joint or splice of the belt reaches the area 9 where the latter is subjected to the radiation emitted from the source 2 and the reflected/refracted radiation is acquired by sensor 3, the belt stops by the time required by source 2 to irradiate the joint or splice and sensor 3 to detect the image of the irradiated joint or splice. The user of the apparatus, and/or the processing and control system 4, when arranged for the automatic control of the apparatus; may determine the operative modes of the means 1, including the possible intermittent feeding of the belt.

This intermittent feeding of the belt can be required in the event, which happens very frequently, that the acquisition of the radiations reflected/refracted from the belt by sensor 3 occurs in an instantaneous and not continuous manner, i.e. by acquiring a static image of the joint or splice to be inspected. In this case, the relative movement of the belt relative to the sensor 3 and source 2, or vice versa, the emission of radiations from source 2 and the acquisition by sensor 3 of the radiations from the belt require to be properly synchronized.

To this purpose, the apparatus for detecting defects in the joints or splices of rubber or other flexible material sheets according to the present invention may provide suitable actuators which are driven by control means, preferably being programmable, which determine the activity and inactivity both of the radiation source 2 and sensor 3 over time. These control means, which are known per se, can be implemented in the above processing and control system 4.

Alternatively, the means 1 can be arranged such as to move the belt continuously and, when a joint or splice of the belt is in correspondence to the acquisition area 9, a processing and control system 4 can determine the instant acquisition by sensor 3 of the electromagnetic radiation reflected/refracted from the joint or splicing, both completely or in part. In this case, the sensor 3, or other suitable sensors, can be able to readily detect that the joint or splice is arranged within the acquisition area 9 and hence they can be able to provide the processing and control system 4 with this information, such that the system 4 commands the acquisition and subsequent processing of the radiations from the joint or splice of the belt.

Both when the belt is moved continuously and when the belt is moved in an intermittent way, further mechanical or optical sensors (not illustrated) may be provided in order to detect the transit of the joint or splice to be inspected in correspondence to said acquisition area 9, i.e. in correspondence to the radiation source 2 and to the sensor 3.

FIG. 4 schematically illustrates another embodiment of the detection apparatus according to the present invention.

In this embodiment, like in the embodiment from FIG. 1-3, a sensor 103 acquiring the reflected/refracted radiation from a joint or splice between two rubber or other material sheets 105, 106 is arranged above the margins (i.e. end edges) 105, 106 such that its detection axis is substantially orthogonal relative to the surface on which these sheets 105, 106 are laid. The detection area 109 of sensor 103 is either rectangular or square, and extends such as to completely surround this joint or splice of the margins 105, 106.

It should be noted that the detection axis of sensor 103 can be generically incident and non-orthogonal to the laying surface of margins 105, 106, without for this compromising the functionality of the detection apparatus as illustrated herein.

Unlike the apparatus being depicted in FIG. 1-3, the source of non-unidirectional directions 102 is arranged substantially beside the belt comprising the sheets 105, 106, without the emitted radiation 107 obliquely hitting the joint or splice of the margins 105, 106.

This arrangement of the source 102 is made possible by the apparatus from FIG. 4 being arranged to detect possible head-to-head, i.e. frontal, defects between margins 105, 106, whereby the shadows between both margins 105, 106 cannot be normally used for detecting these defects.

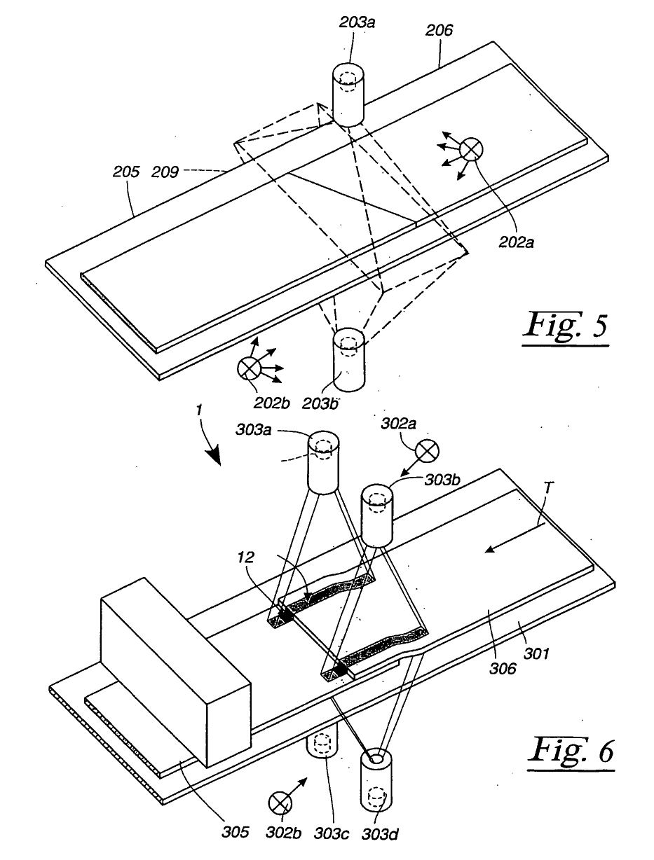

In FIG. 5 there is depicted another embodiment of the present invention, in which there are provided at least two sensors 203a, 203b detecting the radiation hitting the belt and at least two corresponding sources of non-unidirectional radiations 202a, 202b.

The sources of non-unidirectional radiations 202a, 202b and the corresponding sensors 203a, 203b are advantageously arranged on opposite sides relative to the sheets 205, 206 of which the joint or splice has to be detected. Thereby, the sensors 203a, 203b and sources 202a, 202b define two acquisition areas 209, one on either side of the belt, which allow a more accurate identification of defects in the joint or splice, above all when end edges of the sheets forming said joint or splice are overlapped.

FIG. 6 shows a further embodiment of the apparatus according to the present invention, wherein two two-dimensional sensors 303a, 303b are placed above the belt formed by the juxtaposed sheets 305, 306, and two two-dimensional sensors 303c, 303d are placed below said belt. Sources of non-unidirectional radiations 302a and 302b are disposed above and below the belt respectively, their optical axis being oblique with respect to the belt. The apparatus further comprises means 301 for conveying the belt in correspondence to said sensors 303a, 303b, 303c, 303d and to said sources 302a, 302b.

Acquisition areas 309a, 309b of upper sensors 303a,303b are placed at the lateral edges of the sheets 305, 306, as well as the acquisition areas (not shown) of lower sensors 303c, 303d.

In this way, a detection of misalignments of the two sheets concurring in the joint or splice is easily accomplished.

According to the invention, the apparatus herein described implements the following method for detecting defects and or geometric characteristics in at least one joint or splice of sheet pieces, in a unloaded state:

a. subjecting the joint or splice to a non-unidirectional electromagnetic radiation;

b. performing a two-dimensional detection of the radiation reflected or refracted by the joint or splice;

c. generating output signals corresponding to afore-said two-dimensional detection;

d. determining possible defects or the geometrical characteristics of at least part of the joint or splice, by analysing said output signals.

Thus, the operation of the apparatus according to the present invention, with reference to FIG. 1-6, may be generally carried out by means of the following steps:

a. placing the joint or splice in correspondence to at least one source of electromagnetic non-unidirectional radiations 2, 102, 202a, 202b, 302a, 302b and to at least one detection sensor 3, 103, 203a, 203b, 303a, 303b, 303c, 303d which is able to carry out two-dimensional detections of the radiation being emitted from source 2, 102, 202a, 202b, 302a, 302b;

b. operating the source, or sources 2, 102, 202a, 202b, 302a, 302b to subject said joint or splice to the non-unidirectional electromagnetic radiation;

c. operating the sensor, or sensors 3, 103, 203a, 203b, 303a, 303b, 303c, 303d to detect the radiation reflected/refracted by the joint or splice;

d. analyzing the output signal from the sensor, or sensors, 3, 103, 203a, 203b, 303a, 303b, 303c, 303d to identify possible defects.

As regards to the analysis of the output signal from the sensor, or sensors, 3, 103, 203a, 203b, 303a, 303b, 303c, 303d this output signal, according to the known technique, can be digitalized if required and then subjected to pre-processing for example by means convolution masks, and/or Sobel filters, and/or profile detectors in general, and/or blob analysis and/or a Fast Fourier Transform, as well as other optional filtering or processing. The signal thus deprived of noise, as much as possible, is then analyzed for anomalies referable to the presence of defects in the joint or splice to which the signal is related (e.g. by derivative analysis or contour/edge analysis techniques). These processing on the output signal from the sensor, or sensors 3, 103, 203a, 203b, 303, 303b, 303c, 303d can be carried out by the processing and control system 4 such as depicted in FIG. 1.

According to a preferred aspect of the method of the present invention, above all when two-dimensional detection of the joint or splice is carried out both above and below the belt formed by the rubber or other flexible material sheets 5, 6, possible misalignment defects in the end edges (margins) of the sheets may be detected by analysing the output signal with a profile detectors (or a derivative analysis) so that the respective locations of said end edges can be determined.

According to a preferred embodiment of this method, such as mentioned above, the acquisition by the sensor, or sensors, 3, 103, 203a, 203b, 303a, 303b, 303c, 303d of the radiation reflected/refracted from the belt (or other belt-like product) can occur in an instant manner, and not in a continuous manner, and, accordingly, the displacement of the belt relative to these sensors 3, 103, 203a, 203b, 303a, 303b,303c, 303d, or vice versa, can occur in an intermittent manner, a pause being provided when the joint or splice of the belt sheets is placed in correspondence to the above acquisition area 9, 109, 209, 309a, 309b. Analogously, the operation of the source, or sources, of non-unidirectional radiations 2, 102, 202a, 202b, 302a, 302b can be intermittent and preferably synchronized with the acquisition operation carried out by the sensor, or sensors, 3, 103, 203a, 203b, 303a, 303b, 303c, 303d. The intermittence of the displacement of belt relative to the sensors 3, 103, 203a, 203b, 303a, 303b, 303c, 303d or vice versa, can be determined by a feeding command, that may be manually given by an operator, or automatically controlled by control means.

In the event that the automatic control of the detection apparatus is provided, according to the present invention, the processing and control system 4 can interrupt the displacement of the belt relative to the sensors 3, 103, 203a, 203b, 303a, 303b, 303c, 303d and the radiation sources 2, 102, 202a, 202b, 302a, 302b or vice versa, whenever it identifies a defect in the joint or splice being inspected and signals this defect to the operator. The processing and control system 4 can thus allow the apparatus to restart only following an intervention by the operator.

Alternatively, according to a different aspect of the method according to the present invention, the acquisition by the sensor, or sensors 3, 103, 203a, 203b, 303a, 303b, 303c, 303d of the radiation 8 reflected/refracted from the belt-like product can occur in a continuous manner and, accordingly, the displacement of the belt relative to these sensors 3, 103, 203a, 203b, 303a, 303b, 303c, 303d or vice versa can occur in a non-intermittent manner.

According to another aspect of the method of the present invention, the displacement of the belt relative to the sensors 3, 103, 203a, 203b, 303a, 303b, 303c, 303d can be continuous and the acquisition by these sensors 3, 103, 203a, 203b, 303a, 303b, 303c, 303d of the reflected/refracted radiation from the belt can instead occur in an intermittent manner, upon identification of the joint or splice that one desires to inspect within the acquisition area 9, 109, 209, 309a, 309b of the detecting apparatus.

According to a particular aspect of the method of the present invention, it is provided a calibrating phase including the following steps:

a. placing a straightedge in correspondence to at least one source 2, 102, 202a, 202b, 302a, 302b of non-unidirectional electromagnetic radiation and in correspondence to one or more sensors 3, 103, 203a, 203b, 303a, 303b, 303c, 303d for performing said two-dimensional detection;

b. subjecting said joint or splice to a non-unidirectional electromagnetic radiation;

c. performing a two-dimensional detection of the radiation reflected or refracted by the joint or splice;

d. generating calibration output signals corresponding to said two-dimensional detection;

e. storing said calibration signals as a comparand for subsequent output signals.

In this way, if sensors 3, 103, 203a, 203b, 303a, 303b, 303c, 303d are misaligned one with respect to the other or with respect to the belt formed by the sheets 5, 6, output signals coming from said sensors 3, 103, 203a, 203b, 303a, 303b, 303c, 303d are corrected with said calibration signals in order to obtain consistent detections from the same sensors 3, 103, 203a, 203b, 303a, 303b, 303c, 303d.

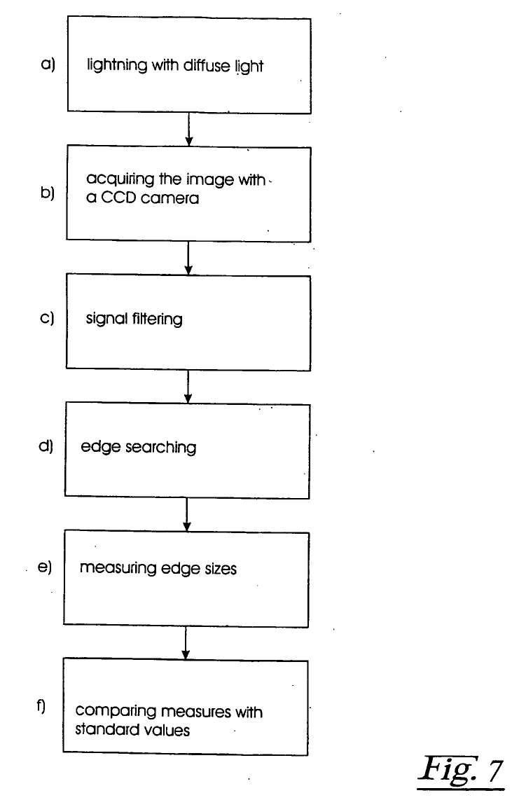

FIG. 7 illustrates a simplified block diagram relating to a possible defect-detecting method, according to a particular aspect of the present invention, which can be implemented in an apparatus of the type described above, having at least one source of non-directional radiations consisting of a source of diffused light and at least one detection sensor comprising a CCD or C/MOS video camera which is capable of emitting a digital signal. In the description below, for simplicity reasons, reference will be also made to the apparatus illustrated in FIG. 1-3 but it should be understood that this method can be as well implemented in the apparatuses shown in FIGS. 4, 5 and 6.

The method illustrated in FIG. 7 provides a first lightning step (a) by means of the light 7 emitted by the source 2, of the acquisition area 9, where due to the means 1, there has been arranged a joint between sheets 5, 6 of a rubber or other flexible material sheet.

Detection of the transit (i.e. of the displacement) of the joint or splice in correspondence to said acquisition area 9, by means of appropriate mechanical or optical sensors (not shown), should be accomplished before said step (a) of lightning the area 9 is carried out.

Substantially simultaneously to this lightning step (a), is also provided a step (b) of acquiring the radiation 8 being reflected from the joint between. the sheets 5, 6 by the matrix CCD or C/MOS video camera 3. The matrix CCD or C/MOS video camera 3, either with levels of grey or colour, is thus capable of outputting a two-dimensional image signal, which is normally referable to a matrix [mXn] in which each value represents the luminosity (or colour) f(x, y) of each pixel (x, y) of the image (where x [□ υ1;m] e y[□ 1;n].

In this case, the image-acquisition area 9, such as defined by the lens system of the CCD or C/MOS video camera and sensor, is substantially rectangular or square and is defined such as to substantially surround the whole joint between the sheets 5, 6.

In the event that, due to the inclination of the emitting axis of the source 2 relative to the laying surface of the belt, a shadow 10 is produced (in the event of joints with overlapped margins) of a margin (i.e. end edge) relative to another one of the sheets 5, 6, the acquisition area 9 extends such as to comprise also the extension area, as expected, of the shadow 10.

The digital output signal from the matrix CCD or C/MOS video camera 3 can be thus pre-processed and filtered (step (c)), to eliminate the noises that may be present, for example using a Fourier Transform on the line and column values of said image signal matrix, being implemented by means of the FFT algorithm (Fast Fourier Transform) in the processing and control system 4.

To this step (c) of pre-processing and filtering the signal there may follow a step (d) of searching the edges (or contours) in the image signal, aiming at identifying the geometric conformation (in a plan view) of the joint of sheets 5, 6, optionally the shadow 10 thereof, and side edges of the joined margins 5, 6. With matrix CCD or C/MOS video camera with levels of grey, the edges of the joint, or shadow 10, and the side edges of the sheets 5, 6 can be identified by means of known algorithms based on the grey gradients between adjacent pixels.

An overview, although being dated, of the possible processing techniques of image signals can be found in Fu, Gonzales, Lee “Robotica”, Mc Graw-Hill (Italia), 1989.

After the edges (or contours) of the above elements have been detected, a subsequent step (e) of measuring and analyzing these edges and sizes of the objects to which they refer and identification of these objects, preludes to a subsequent step (f) of comparing these measures with preset standard admissibility values of the possible defects, or a step of comparing the detected edges with a set of acceptable sample edges, by means of techniques of pattern-matching, which are known per se.

In the event of defects due to: misalignment of the sheets 5, 6, i.e. non-linearity of the edge of the sheets 5, 6 in correspondence to the joint, or separation of the margins 5, 6 or deformation and/or wrong arrangements in the joined margins 5, 6, the comparison between the measurements obtained from the image signal and the acceptable standard values allows to automatically identify the type of defect and the quantitative extension thereof, and thus allows to subsequently provide the operator with a complete signalling of the defect.

Although the above detailed description of some embodiments of the present invention particularly relates to the detection of defects in joints or splices of rubber sheets for the manufacture of waists and/or carcasses of pneumatic tyres, the present invention, as those skilled in the art may readily appreciate, is not limited to this particular field, but is to be regarded as being referred to all those manufacturing sectors where two flexible material margins are juxtaposed and then joined or spliced (for example by means of welding) to form a belt or product which is at least partially belt-like.

1. A method for detecting defects in, and/or geometrical characteristics of, at least one joint or splice of sheet pieces, in a unloaded state, characterised by the following steps:
a. subjecting said joint or splice to a non-unidirectional electromagnetic radiation;
b. performing a two-dimensional detection of the radiation reflected or refracted by said joint or splice;
c. generating output signals corresponding to said two-dimensional detection;
d. determining possible defects or the geometrical characteristics of at least part of said joint or splice, by analysing said output signals.

2. A method according to claim 1, characterised in that said radiation is directed both above and below said joint or splice and the radiation reflected or refracted by the joint or splice is detected both above and below said sheet pieces.

3. A method according to anyone of the preceding claims, in which said sheet pieces are rubber or other flexible material sheets.

4. A method according to anyone of the preceding claims, wherein said sheet pieces are stopped when said at least one joint or splice of said pieces is placed in correspondence to at least one source of non-unidirectional electromagnetic radiation and to at least one sensor which is able to perform a two-dimensional detection of the radiation reflected or refracted by said joint or splice, the sheet pieces being moved again after said steps of subjecting said joint or splice to a non-unidirectional electromagnetic radiation and of performing a two-dimensional detection of the radiation reflected or refracted by said joint or splice are accomplished.

5. A method according to anyone of the preceding claims, wherein said steps of subjecting said joint or splice to a non-unidirectional electromagnetic radiation and of performing a two-dimensional detection of the radiation reflected or refracted by said joint or splice are accomplished after the step of detecting the transit of said at least one splice or joint in correspondence to at least one source of non-unidirectional electromagnetic radiation and to one or more sensors for performing said two-dimensional detection.

6. A method according to anyone of the preceding claims, characterised in that the output signals are digital signals or analogical signals subsequently converted in digital signals, said method being characterised in that said step of analysing the output signals comprises treating said output signals by means of a convolution mask, or a Sobel filter, or a profile detector, or a blob analysis or a Fast Fourier Transformation (FFT), or a derivative analysis.

7. A method according to anyone of the preceding claims, characterised in that said output signals of said two-dimensional detection correspond to an image of at least part of said joint or splice.

8. A method according to claim 7, wherein said output signals are digital or digitalised signals, and said analysis of the output signals includes a first step of detecting the edges of the objects in said image, and a subsequent step of measuring and/or analysing at least one of said edges.

9. A method according to anyone of the preceding claims, characterised in that said analysis of the output signals comprises the step of determining the respective locations of the end edges of the sheet pieces involved in said at least one joint or splice.

10. A method according to claim 9, wherein the difference of the locations of the end edges of the sheet pieces involved in said joint or splice is used to determine possible defects or the geometrical characteristics of said joint or splice.

11. A method according to anyone of the preceding claims, characterised by comprising a calibrating phase including the following steps:
a. placing a straightedge in correspondence to at least one source of non-unidirectional electromagnetic radiation and to one or more sensors for performing said two-dimensional detection;
b. subjecting said joint or splice to a non-unidirectional electromagnetic radiation;
c. performing a two-dimensional detection of the radiation reflected or refracted by said joint or splice;
d. generating calibration output signals corresponding to said two-dimensional detection;
e. storing said calibration signals as a comparand for subsequent output signals.

12. A method according to anyone of the preceding claim, characterised in that the non-unidirectional electromagnetic radiation emitting spontaneous.

13. Apparatus for detecting defects or geometrical characteristics in joints or splices of sheet pieces in a unloaded state, according to the method claimed in any one of the preceding claims, the apparatus comprising:
a. at least one source of electromagnetic radiations which are suited to be directed towards at least one of said joints or splices;
b. one or more sensors which can detect the radiation reflected or refracted by said at least one joint or splice;
characterised in that:
c. said at least one radiation source is a source of electromagnetic non-unidirectional radiations; and
d. said one or more sensors make a two-dimensional detection of said reflected or refracted radiation.

14. Apparatus according to claim 13, characterised by comprising at least one first sensor which detects the radiation reflected or refracted by the upper surface of the joint or splice, and at least one second sensor which detects the radiation reflected or refracted by the lower surface of the joint or splice.

15. Apparatus according to claim 14, wherein at least two sensors detect the radiation reflected or refracted by the upper surface of the joint or splice, and at least two sensors detect the radiation reflected or refracted by the lower surface of the joint or splice, acquisition areas of said sensors being placed at the lateral edges of the sheet pieces involved in said joints or splices.

16. Apparatus according to anyone of claim 14 or claim 15, characterised by comprising at least one first source of electromagnetic non-unidirectional radiation placed above said upper surface of the joint or splice, the radiation of said first source impinging thereon, and at least one second source of electromagnetic non-unidirectional radiation placed below said lower surface of the joint or splice, the radiation of said second source impinging thereon.

17. Apparatus according to anyone of claims 13 to 16, further comprising sensing means for detecting the transit of said at least one splice or joint in correspondence to at least one of said one or more sensors and to said at least one source of non-unidirectional electromagnetic radiations.

18. Apparatus according to anyone of claims 13 to 17, wherein at least one of said one or more sensors is a matrix CCD or C/MOS camera.

19. Apparatus according to claim 18, wherein said matrix CCD or C/MOS camera is a multi-level grey camera or a colour camera.

20. Apparatus according to anyone of claims 13 to 18, wherein at least one of said one or more sensors is a combination of two or more linear CCD or C/MOS camera.

21. Apparatus according to anyone of claims 13 to 20, wherein said at least one source of electromagnetic radiation is chosen among: infrared sources, ultraviolet sources, diffused light sources, X-Ray sources.

22. Apparatus according to anyone of claims 13 to 21, further comprising means for conveying said sheet pieces in correspondence to said at least one source and to said one or more sensors, or vice-versa.

23. Apparatus according to claims 22, characterised by comprising control means to regulate the operation of said means for conveying said sheet pieces in correspondence to said at least one source and to said one or more sensors, or vice-versa.

24. Apparatus according to claim 23, wherein said control means are automatic control means.

25. Apparatus according to anyone of claims 13 to 24, further comprising processing means for analysing the output signals from said one or more sensors.

26. Apparatus according to anyone of claims 13 to 25, wherein the source of electromagnetic radiations emitting spontaneous.
